(19) United States
(12) Patent Application Publication
(10) Pub. No.: US 2014/0224376 A1
(43) Pub. Date: Aug. 14, 2014

(54) METHODS AND SYSTEMS FOR BUFFERING SOLUTIONS WITH CONTROLLED TONICITY

(71) Applicants: Matthew J. Stepovich, Santa Cruz, CA (US); Michael I. Falkel, Carmel Highlands, CA (US); Mark Foley, Atlanta, GA (US)

(72) Inventors: Matthew J. Stepovich, Santa Cruz, CA (US); Michael I. Falkel, Carmel Highlands, CA (US); Mark Foley, Atlanta, GA (US)

(73) Assignee: Onpharma, Inc., Los Gatos, CA (US)

(21) Appl. No.: 13/767,692

(22) Filed: Feb. 14, 2013

(51) Int. Cl. A61J 1/20; A61J 1/14

(52) U.S. Cl. CPC A61J 1/2096; A61J 1/1406
USPC 141/1; 604/415

(57) ABSTRACT

An anesthetic cartridge is adapted to receive a volume of buffer by displacing a plunger in one end of the anesthetic cartridge inwardly so that addition of the buffer volume will not displace the plunger excessively beyond the end of the cartridge body. The inwardly displaced end is protected by a plug or cover which prevents contamination and which is ejected when the buffer is added. The amount of buffer volume injected is selected to raise the pH of the anesthetic to a target value and to simultaneously achieve a target tonicity.

### BACKGROUND OF THE INVENTION

1. Field of the Invention

The present invention relates generally to methods and apparatuses for buffering anesthetic cartridges. More specifically, the present invention relates to methods and devices for delivering an amount of buffering solution to an anesthetic cartridge to achieve a target pH and tonicity with a minimum of waste.

Cartridges of local anesthetic commonly used in dentistry (herein “dental anesthetic cartridges”) are filled nearly completely with anesthetic where the cartridge's plunger is located at or near the end of the cartridge. The anesthetic is typically delivered by loading the cartridge into a breach in a reusable stainless steel dental syringe to which a disposable hypodermic needle has been attached. After the anesthetic has been delivered and the dental procedure is complete, the needle and the anesthetic cartridge are discarded and the syringe is steam sterilized. Anesthetic cartridges are sometime used by dentists in other automated delivery systems for instance in the system disclosed in U.S. Pat. No. 7,896,833.

The solutions in most dental anesthetic cartridges are acidic, and it is beneficial to raise the pH of the anesthetic, or buffer the anesthetic, just prior to delivery, in order to reduce injection pain, improve profundity, reduce anesthetic failure, and speed the onset of analgesia. Buffering the anesthetic inside the cartridge immediately prior to delivery allows the dental practitioner to subsequently deliver the anesthetic using his or her normal technique and cartridge-based delivery system, which is convenient.

Such a buffering process that adds buffering solution to a sealed anesthetic cartridge, however, is problematic since adding the buffer to the volume of anesthetic already in the cartridge displaces the cartridge's plunger, potentially pushing the plunger partially or fully out of the end of the cartridge.

A method and apparatus for buffering anesthetic cartridges that prevent such plunger displacement are disclosed in commonly assigned U.S. Patent Publ. No. 2011/0247722, the full disclosure of which is incorporated herein by reference. A plunger at one end of an anesthetic cartridge is initially inset from the end of the cartridge so that addition of an expected volume of buffer will not displace the plunger excessively beyond the end of the cartridge body. While functional, such inward offset of the plunger exposes an inner surface of the cartridge to the potential contamination prior to use.

The tonicity of a medical solution is a measure of the solutes contained in the solution and can be expressed as osmolarity with units of milliosmoles of solute per liter (mOsm/L). The optimal tonicity for anesthetics and other injected medical solutions is “isotonic,” i.e. the osmolarity of the human body which is approximately 300 mOsm/L.

Local anesthetics are typically hypertonic as manufactured and delivered in dental anesthetic cartridges. For instance, 2% lidocaine with epinephrine at a concentration of 1:100,000 has been measured at 343 mOsm/L. Loiselle R J, Sawinski V J, Goldberg A F, Anesthesia Progress, April 1966, pp. 95-96. Cartridges of local anesthetics with vasoconstrictors, such as 2% lidocaine with epinephrine in a concentration of 1:100,000, are also typically quite acidic, having a pH in the range of 3.5-5.5. As they are maintained under normal storage conditions in inventory, over time, these cartridges become even more acidic. Studies have measured cartridges of 2% lidocaine with epinephrine in a concentration of 1:100,000 that have yet to reach their expiration dates at pH 2.86. Hondrum S O, Ezell J H, Anesthesia Progress, 1996, Volume 43, No. 3, pp. 85-91. While it is known to buffer such cartridges toward physiologic pH using medical sodium bicarbonate solutions, the addition of sodium bicarbonate will typically make the anesthetic solution even more hypertonic than the unbuffered anesthetic.

For these reasons, it would be desirable to provide improved methods and apparatuses for buffering anesthetic cartridges. In particular, it would be desirable to provide anesthetic and other medical solution cartridges with initially offset plungers where the offset end of the cartridge is protected from contamination prior to use. It would be further beneficial to provide a method for buffering anesthetics and other medical solutions could result in a solution with reduced hypertonicity, preferably an isotonic solution, than it would otherwise be. It would be still further desirable to provide methods for combining buffers with anesthetics and other medical solution where a predetermined volume of buffer can be added to achieve both a target pH and a target tonicity. At least some of these objectives will be met by the inventions described below.

2. Description of the Background Art

Glass cartridges for storing and delivering anesthetic solutions and delivery systems for the same are described in U.S. Pat. Nos. 3,556,099, 4,472,141, and 5,368,572. U.S. Pat. No. 5,603,695 describes an anesthetic cartridge which is only partially filled to allow addition of buffer without plunger displacement. Commonly owned U.S. Patent Publ. No. 2011/0247722 has been described above. Other commonly owned patents and published applications relating to buffer addition include U.S. Pat. Nos. 8,162,917 and 8,303,566 and U.S. Patent Publ. Nos. 2012/0180432; 2011/0282316; 2011/0005958; 2011/0165017; and 2012/02799179, the full disclosures of which are incorporated herein by reference. Loiselle R J, Sawinski V J, Goldberg A F, Anesthesia Progress, April 1966, pp. 95-96; and Hondrum S O, Ezell J H, Anesthesia Progress, 1996, Volume 43, No. 3, pp. 85-9, have been described above.

### BRIEF SUMMARY OF THE INVENTION

The present invention provides methods and systems for buffering anesthetics with buffer solution to raise the pH in order to improve anesthetic effectiveness, speed anesthetic onset time, and reduce patient discomfort. The method and systems are useful with a variety of slightly acidic anesthetics, including amide local anesthetics and amine local anesthetics, such as Lidocaine and Articaine, which are commonly used in dental procedures. The methods and systems of the present invention, however, are not intended to be limited to those particular examples and may find use with a wide variety of anesthetic solutions, buffer solutions, medical solutions other than anesthetics, different medical procedures, and the like.

More particularly, in a first aspect of the present invention, cartridges and other containers of local anesthetics and other medical solutions are prepared to have a reduced tonicity, i.e. a lower concentration of solutes, than found in most standard anesthetic solutions currently available in the marketplace. Such controlled tonicity is achieved by providing a hypotonic anesthetic or other medical solution in the container prior to buffering. The buffer is made slightly hypertonic so that after the addition to the anesthetic or other medical solution, the combined solution will be within an optimal range of tonicity as well as having a targeted pH.

In specific embodiments of the present invention, the anesthetic or other medical solution contains a vasoconstrictor, such as epinephrine, where the concentration of vasoconstrictor in the pre-buffered anesthetic cartridge is selected so that, after addition of the buffer, the concentration of vasoconstrictor in the buffered solution will be at a target level, e.g. at a standard ratio for such anesthetics, for instance at a ratio of 1:200,000, 1:100,000, or 1:50,000 epinephrine:anesthetic solution.

In a second aspect of the present invention, an anesthetic cartridge or other medical solution container has a reduced volume of solution (compared to a standard container) with a dispensing plunger initially inset so that solution fills the interior between the plunger and a needle septum. Such inward displacement of the plunger leaves an open region where the interior wall of the container may be exposed to contamination. In accordance with the present invention, a plug, cover or other protective element is placed in and/or over the open end of the container or cartridge to protect the plunger and prevent contamination prior to use. Preferably, the plug, cover or other element will be configured so that it will be pushed out by displacement of the plunger as buffer is added to the container.

In a third aspect of the present invention, the cartridge or other container includes a mechanism or component which prevents the anesthetic cartridge or other container from being used prior to addition of the buffer. Usually, the plug, cover or other element used for sterility (as described above) will also serve to block the plunger and will be removed only by the addition of buffer. In particular, the plug or cover can be designed so that it is difficult to remove in any manner other than by injecting the buffer. Thus, blocking of the plunger will prevent the cartridge or other container from being used with a standard re-usable syringe or other delivery mechanism until the pH buffer has been injected, and a practitioner is prevented from inadvertently delivering the anesthetic or other medical solution until the solution is ready for use.

A liquid medicament cartridge according to the present invention comprises a hollow body having a first open end and a second open end. A needle-penetrable septum covers the first open end, and a plunger is spaced inwardly from the second open end, leaving an open inset region with an exposed inner wall. To prevent contamination, a protective plug is inserted into the second open end. The protective plug is displaceable as liquid buffer is injected through the septum into the hollow body to cause the plunger to move toward the plug. The plug is preferably configured so that it is difficult to remove in any way other than by injecting the buffer through the septum. Thus, the cartridge is prevented from being used before the buffer has been introduced. In particular, the plug will prevent the cartridge from being placed in a standard syringe, and the anesthetic or other medical solution cannot be injected into a patient before it has been buffered.

In specific embodiments, the hollow body comprises a glass tube and the protective plug has a distal end which engages the plunger and a proximal end which covers the second opening to maintain sterility. The proximal end of the plug is preferably configured so that it cannot be pushed into the second open end of the hollow body to prevent premature inward displacement of the plunger. For instance, the proximal end of the plug may configured so that it is difficult to be manually grasped when present in or over the second open end of the hollow body and is easier to grasp when displaced proximally from the second open end.

A method according to the present invention for buffering an anesthetic carried in a cartridge or other container comprises injecting a buffer into the contents of the container to outwardly displace a plunger which in turn ejects a protective plug which covers the plunger. In specific embodiments, the protective plug prevents contamination of the cartridge prior to ejection and/or prevents premature use of the cartridge in a syringe. The plug will usually also prevent inward displacement of the plunger prior to ejection of the plug. The plunger is typically configured so that it cannot be pushed into the container.

A further method according to the present invention provides for buffering a liquid anesthetic to a target tonicity and a target pH. The method comprises providing a volume of the liquid anesthetic or other medical solution in a sealed container having a septum at one end and a plunger at an opposite end. The anesthetic is initially acidic, and a volume of buffer is injected through the septum into the anesthetic.

The buffer is hypertonic and has a basic pH selected so that the buffered anesthetic will have both the target pH and the target tonicity after combination the buffer and anesthetic are combined. The target tonicity is usually less than 500 mOsm/kg, more usually being less than 400 mOsm/kg, and preferably being substantially isotonic (about 300 mOsm/kg). The anesthetic typically has an initial pH below 6.0 (before buffering) and the volume of buffer raises the pH of the buffered anesthetic to a target pH of at least 7.0, usually to a target pH of at least 7.3.

The hypertonic buffer is usually a sodium bicarbonate buffer and typically comprises sodium chloride as the solute principally responsible for the tonicity. The anesthetic solution may further comprise a vasoconstrictor, typically epinephrine. The amount of epinephrine or other vasoconstrictor present in the anesthetic will usually also be selected to be at a preselected concentration after combination with the buffer, typically at a ratio of 1:200,000, 1:100,000, or 1:50,000 (epinephrine:anesthetic solution).

In other specific embodiments, the cartridge may be prepared at a central manufacturing facility and the cartridges may be distributed to a plurality of local users, wherein the users individually inject the buffer to produce buffered anesthetic for use in a procedure. Typically, at least a portion of the buffered anesthetic is injected into a patient within two minutes of introducing the buffer. The anesthetics are typically a local anesthetic, such as an amide local anesthetic or an amine local anesthetic. Exemplary local anesthetics include lidocaine and articaine. The anesthetic cartridge may have an internal volume in the range from 1.45 ml to 2.3 ml, where an anesthetic volume is in the range from 1.15 ml to 2.2 ml, and an injected buffer volume in the range from 0.1 ml to 0.35 ml.

### BRIEF DESCRIPTION OF THE DRAWINGS

FIG. 1 illustrates a conventional and aesthetic cartridge having a plunger disposed near a plunger end of the cartridge in order to maximize the volume of an anesthetic within the cartridge.

FIG. 2 illustrates an anesthetic cartridge as described in commonly owned US2011/0247722 where the plunger has been inset from the plunger end of the cartridge in order to provide a potential volume within the container for receiving a selected volume of buffer solution. The inset end is protected by a cover.

FIG. 3 illustrates an anesthetic cartridge having an inset plunger protected by a displaceable plug in accordance with the present invention. Buffer is being transferred a buffer container into an anesthetic volume within the anesthetic cartridge.

FIG. 4 illustrates the anesthetic cartridge of FIG. 3 where the plug has been displaced by movement of the plunger as a result of buffer having been introduced into the anesthetic volume within the cartridge.

### DETAILED DESCRIPTION OF THE INVENTION

The present invention provides methods and systems for using a dental anesthetic cartridge or other medical solution container as a mixing vessel for combining an anesthetic or other medical solution with a buffering solution from a separate container. In an embodiment of the current invention, the problems associated with plunger displacement during pH buffering are overcome by configuring a dental anesthetic cartridge for use with a system that delivers a precise amount of buffering solution to the cartridge, using the anesthetic cartridge itself as the mixing chamber to combine the buffer solution and the anesthetic solution, while displacing the plunger no more than a precise amount calculated to allow the plunger to move a predetermined distance sufficient to accept the buffer solution without displacing the plunger past the end of the cartridge. A plug, cover or other element covers and protects the plunger end of the container which would otherwise be open to contamination. The plug or cover is configured so that it cannot be easily removed other than by injecting buffer into the container. As the buffer will not be injected until the anesthetic or other medical solution is ready for use, the possibility that the anesthetic will be used prematurely and/or that the cartridge will be contaminated prior to use is significantly reduced.

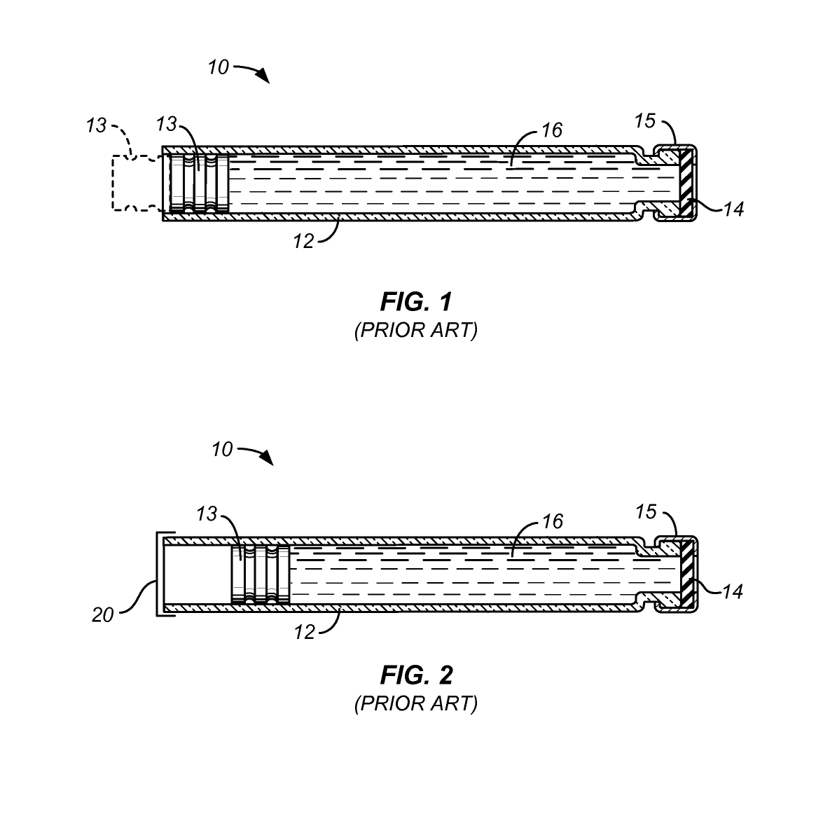

A conventional anesthetic cartridge 10 is illustrated in FIG. 1 and includes a glass tube 12, a plunger 13 at one end of the glass tube 12, a pierceable septum 14 at the other end of the glass tube, and a cap 15 covering the septum 14. An interior volume 16 of the glass tube 12 is filled with an anesthetic solution, typically as described above. As can be seen in FIG. 1, if any significant volume of buffer were to be added to the volume of anesthetic which fills the interior 16 of the glass tube, the plunger 13 would be displaced outwardly, as shown in broken line in FIG. 1. While the displaced plunger 13 in FIG. 1 is only partially displaced, it would be appreciated a slightly greater volume of buffer would completely dislodge the plunger from the tube, allowing the anesthetic and buffer to spill. Even if the plunger 13 were only slightly displaced from the glass tube 12, it is likely that the cartridge 10 would still not be useable since it would be difficult, if not impossible, to place the cartridge into most syringe assemblies intending to receive the cartridge, where the plunger 13 is expected to be flush within the glass tube 12.

As disclosed in commonly owned U.S. Patent Publ. No. 2011/0247722, an improved arrangement of the anesthetic cartridge 10 has the plunger 13 initially displaced inwardly from the end of the cartridge, as shown in FIG. 2. If the dimensions of the glass tube 12 are identical to those of the conventional anesthetic cartridge in FIG. 1, then the volume of anesthetic within the cartridge will have been reduced somewhat, but there will be sufficient displacement room for the plunger 13 to move to the left. A membrane cover 20 protects the exposed plunger end of the cartridge from contamination, but the cover is easily removed even long before use. Thus, the cartridge can become contaminated and the cartridge used prematurely prior to the addition of buffer

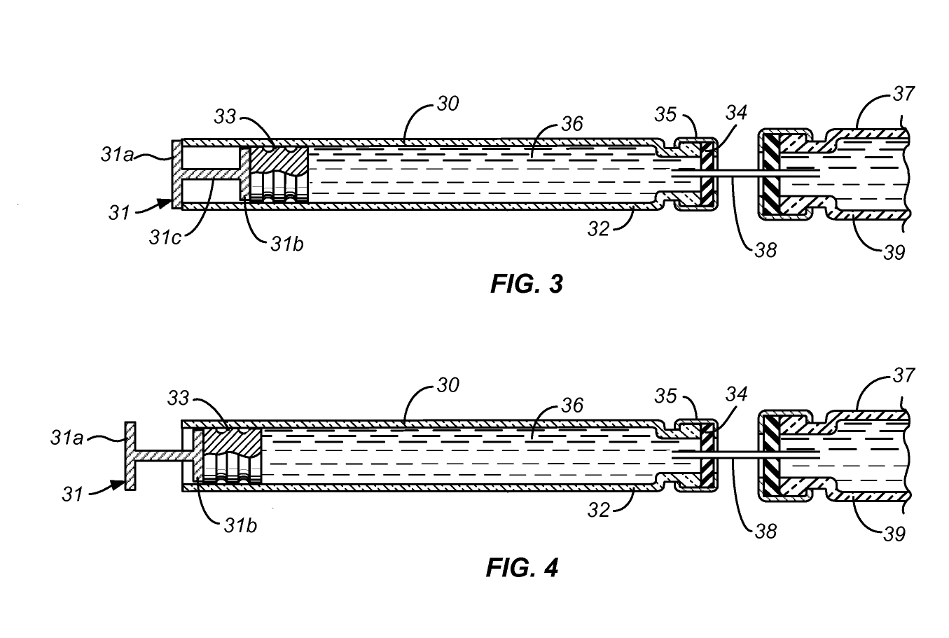

As shown in FIG. 3, a buffer container 37 is used to transfer buffer to an interior 36 of an anesthetic cartridge 30. For example, a transfer tube 38 may be inserted through the septum 34 of the anesthetic cartridge 30 at one end and inserted through the septum 36 of the buffer cartridge 37 at its other end. Thus, a transfer path exists between the buffer solution and the anesthetic solution. Buffer cartridge 37 may itself have a plunger (not illustrated) which allows transfer of the desired buffer volume to the interior 36 of the anesthetic cartridge 30 which will result in displacing ac plunger 33 to the position shown in FIG. 4. A transfer volume will be calculated in this method such that the target pH adjustment and the tonicity adjustment of the anesthetic solution will be achieved without displacing the cartridge 33 beyond the end of the glass tube 32.

Of particular concern to the present invention, a plug 31 is placed in the open plunger end of the glass tube 32. The plug has a proximal end 31a which is configured and dimensioned to sit in, at or just outside of the open end of the glass tube. Preferably, the proximal end will be sized or otherwise configured so that it cannot be pressed or pushed into the open end. A distal end 31 of the plunger 31 is dimensioned to fit inside of the open end of the cartridge and a stem 31c or other portion or component between the proximal and distal ends will have a length selected so that the distal end will just touch the plunger 33 when the proximal end 31a is located at the end of the glass tube 32. Thus, as soon as buffer is injected from the buffer container 37, the plunger 33 will be displaced to the right as illustrated. When the desired volume of buffer has been transferred, the plug 31 will also be displaced to the right so that the proximal end 31a is exposed and can be readily grasped and removed by the user. The cartridge 30 is then ready for insertion into a syringe for use.

By storing a hypotonic anesthetic solution in a sealed cartridge that is intended to be buffered prior to use, it is possible to create an anesthetic that can be buffered to both an optimal pH using a known concentration of sodium bicarbonate solution and to an optimum (or at least acceptable) tonicity, typically where the buffered solution is isotonic after the buffering process has been completed. In this process, a hypotonic local anesthetic solution would be manufactured to a known and precise hypotonic osmolarity selected so that with the addition of a desired amount of a known concentration of sodium bicarbonate solution, for instance 0.18 mL of 8.4% sodium bicarbonate, the resulting mixed solutions would be approximately isotonic (300 mOsm/L). The buffer can be transferred using the simple cartridge 37 as shown in FIGS. 3 and 4 or alternatively can be transferred using the systems described in the commonly assigned patents and publications which have been incorporated herein by reference.

While the above is a description of a preferred embodiment of the invention, various alternatives, modifications, and equivalents may be used. Therefore, the above description should not be taken as limiting the scope of the invention which is disclosed.

What is claimed is:

1. A liquid medicament cartridge comprising:
a hollow body having a first open end and a second open end;
a needle-penetrable septum over the first open end;
a plunger spaced inwardly from the second open end; and
a protective plug inserted into the second open end, said protective plug being displaceable as additional liquid is injected through the septum into the hollow body to cause the plunger to move toward the plug.

2. A medicament cartridge as in claim 1, wherein the hollow body comprises a glass tube.

3. A medicament cartridge as in claim 1, wherein the protective plug has a distal end which engages the plunger and a proximal end which covers the second opening to maintain sterility.

4. A medicament cartridge as in claim 3, wherein the proximal end of the plug is configured so that it cannot be pushed into the second open end of the hollow body to prevent premature inward displacement of the plunger.

5. A medical cartridge as in claim 3, wherein the proximal end of the plug is configured so that it is difficult to manually grasp when present over the second open end of the hollow body and easier to grasp when displaced proximally from the second open end.

6. A method for buffering anesthetic carried in a container, said method comprising:
injecting a buffer into the container to outwardly displace a plunger which in turn ejects a protective plug which covers the plunger.

7. A method as in claim 6, wherein the protective plug prevents contamination of the cartridge prior to ejection.

8. A method as in claim 6, wherein the protective plug prevents inward displacement of the plunger prior to ejection.

9. A method as in claim 6, wherein the plunger is configured so that it cannot be pushed into the container.

10. A method for buffering a liquid anesthetic having a target tonicity and a target pH, said method comprising:
providing a volume of the liquid anesthetic in a sealed container having a septum at one end and a plunger at an opposite end, wherein the anesthetic is initially acidic; and
injecting a volume of buffer through the septum into the anesthetic;
wherein the buffer is hypertonic and has a basic pH selected so that the buffered anesthetic will have both the target pH and the target tonicity.

11. A method as in claim 10, wherein the target tonicity is less than 500 mOsm/kg.

12. A method as in claim 10, wherein the target tonicity is less than 400 mOsm/kg.

13. A method as in claim 10, wherein the target tonicity is substantially isotonic.

14. A method as in claim 10, wherein the anesthetic originally has a pH below 6.0 and the volume of buffer raises the pH of the buffered anesthetic to a target pH of at least 7.0.

15. A method as in claim 14, wherein the volume of buffer increases the pH to a target pH of at least 7.3.

16. A method as in claim 10, wherein the buffer comprises hypertonic sodium chloride.

17. A method as in claim 10, wherein the anesthetic further comprises a vasoconstrictor

18. A method as in claim 17, wherein the vasoconstrictor comprises epinephrine.

19. A method as in claim 10, wherein the buffer comprises sodium bicarbonate.

20. A method as in claim 10, wherein the cartridge is prepared at a central manufacturing facility and the cartridges are distributed to a plurality of local users, wherein the users inject the buffer.

21. A method as in claim 20, wherein the users inject the buffer prior to a procedure, in order to produce buffered anesthetic for use in the procedure.

22. A method as in claim 21, wherein at least a portion of the buffered anesthetic is injected into a patient within 2 minutes of introducing the buffer.

23. A method as in claim 10, wherein the local anesthetic is an amide local anesthetic.

24. A method as in claim 10, wherein the local anesthetic is an amine local anesthetic.

25. A method as in claim 10, wherein the local anesthetic is lidocaine.

26. A method as in claim 10, wherein the local anesthetic is articaine.

27. A method as in claim 10, wherein an internal volume of the anesthetic cartridge is in the range from 1.45 ml to 2.3 ml, the anesthetic volume is in the range from 1.15 ml to 2.2 ml, and the buffer volume is in the range from 0.1 ml to 0.35 ml.
